(19) United States
(12) Patent Application Publication
(10) Pub. No.: US 2005/0129418 A1
(43) Pub. Date: Jun. 16, 2005

(54) Image forming apparatus and toner supply method

(75) Inventors: Koji Imamiya, Kanagawa-ken (JP); Hiromichi Mitamura, Shizuoka-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/999,930

(22) Filed: Dec. 1, 2004

(30) Foreign Application Priority Data
Dec. 10, 2003 (JP) 2003-411811

(51) Int. Cl. G03G 15/08

(52) U.S. Cl. 399/27; 399/30

(57) ABSTRACT

A revolver type color developing device having a yellow, a magenta and a cyan developing units and a black developing device in a color copier are provided at positions outside the upper area of the image carrier. The vertical conveying path passes through the position outside the lower area of the revolver type color developing device and the black developing device. For detecting density of toners in the developing units of the revolver type color developing device, a toner density sensor to detect amount of infrared light reflecting light is used while a magnetic sensor is used for detecting toner density in the black developing device.

### CROSS-REFERENCE TO RELATED APPLICATION

This application is based upon and claims the benefit of priority from the prior Japanese Patent Application No. 2003-411811, filed on Dec. 10, 2003; the entire contents of which are incorporated herein by reference.

### BACKGROUND OF THE INVENTION

1. Field of the Invention

The present invention relates to an image forming apparatus such as a color printer, a color copier, etc. to form color images on sheets of paper and a toner supply method.

2. Description of the Related Art

A color laser printer is known as an image forming apparatus to form a color image on a sheet of paper as disclosed in the Japanese Patent Application Publication No. 11-84801.

This color laser printer has an image carrier on which latent images are formed by the exposure, plural developing devices to develop this latent images by supply specified color developers, a intermediate transfer belt to transfer color developer images formed on the image carrier by overlapping each other, a transferring device to transfer the color developer images transferred by superposing each other on the intermediate transfer belt, and a transfer unit to transfer color developer images formed on a intermediate transfer belt en block on paper, and a cassette housing a number of sheets of paper.

A yellow, magenta and cyan developing devices are set in a developing device rotary arranged rotatably at the side of the image carrier, and a black developing device is a separate unit from the developing device rotary and arranged opposite to the rotary from above the image carrier. The developing device rotary houses 3 developing devices side by side in its peripheral direction and opposes a specific color developing device to the image carrier by rotating.

The intermediate transfer belt is brought to contact the image carrier from below.

An image receiving medium (paper) taken out of the cassette is conveyed on a conveying path extending nearly in the horizontal direction under the intermediate transfer belt and passes the intermediate transfer belt. At this time, color developer images transferred on the intermediate transfer belt in the overlapped state are transferred on the image receiving medium (paper) in a lump.

However, a conventional printer in the structure as described above has such problems as shown below.

First, as a black developing device is arranged above the image carrier, a developer undesirably scattering from this developing device drops on the image carrier. When a developer falls on the image carrier, this developer is transferred on a sheet by way of a intermediate transfer belt and an image becomes worse (dirty).

Second, because a paper is conveyed on the conveying path under the intermediate transfer belt, color developers undesirably scattered from respective color developing devices set in the developing device rotary and a black developer scattered from the black developing device fall on the paper conveyed on the conveying path. Thus, when developers fall on a paper, an image becomes defective.

The developing devices disclosed here use single-component developers, respectively and it is not necessary to check toner density of a developer in respective developing device.

In general, 2-component developing system has merits in the image quality such as wider expression of gradation and in particular, excellent reproduction of bright halftone. Further, regarding a toner charging amount, a 2-component developing system is higher than a single-component developer and scattering of toners around characters, very small dots and thin lines is less than a single-component developing system. Furthermore, consumables of 2-component developing system are usable for longer than a single-component developing system; for example, developing devices can be used up to the service life of the main body and a running cost per sheet of paper is cheaper than that of a single-component developing system. In recent years, many image forming apparatus in the 2-component developing system are provided in the market.

An example of the 2-component developing system image forming apparatus is disclosed in, for example, the Japanese Patent Application Publication No. 9-218589.

The image forming apparatus in this example has black, cyan, magenta and yellow developing devices. These devices are in the rotatable structure and supported by the main body. Each of the color developing devices is movable to a position to visualize a latent image formed on the photosensitive drum according to need. Developers retained in these developing devices are two-compoent developer and it is necessary to detect density of each toner and control to supply to maintain toners always at specified densities.

In this example, the image forming apparatus has the black, cyan, magenta and yellow developing portions, which are supported rotatably by the main body and therefore, it is difficult to use magnetic sensors that are normally used for detecting toner density of two-compoent developer. This is because it is difficult to install a means to transmit an output signal from a sensor to the main body.

For this reason, in this example, a density sensor is arranged at the downstream side in the peripheral direction of the photosensitive drum of the developing device to detect density of an image developed on the photosensitive drum. The supply of a toner to the developing device, change of developing conditions, etc. are executed according to the density signal from the density sensor, and the toner density of 2-component developer is controlled to maintain always at a specified toner density.

However, in order to detect a toner density according to this toner density supply and control method, it is necessary to form a patch for the density detection by interrupting a print job for every specified number of sheets during the continuous printing. Further, it is also necessary to form a patch for density according to a timing between a sheet and a sheet conveyed. In this case, there were such defects that the printing speed was dropped and toners were consumed undesirably.

### SUMMARY OF THE INVENTION

An object of the present invention is to provide an image forming apparatus using a two-component developer and a toner supply and control method to prevent defective images generated by adhesion of developers without lowering the print speed performance for detecting toner density and undesirably consuming toner.

According to embodiments of the present invention, an image forming apparatus is provided, which comprises an image carrier on which plural latent images are formed repeatedly; a color developing device which has plural first developing units containing specified color developers arranged side by side in a rotating direction and are able to rotate the plural first developing units to oppose to the image carrier selectively and develop the latent images by supplying specified color developers; a second developing device arranged along the outer surface of the image carrier at a position differing from the position where the first developing units of the color developing device is opposed to the image carrier, and opposes to the image carrier and develops the latent image by supplying a specified color developer; a first toner density detecting measns for detecting a toner density of the developers contained in the first developing units, wherein the developers are two-compoent developer comprising at least non-magnetic toner and magnetic carrier; and a second toner density detecting means for detecting the toner densitiy of the developers contained in the second developing device of which detecting method differs from the first toner density detecting means, wherein the developer is a two-component developer comprising at least non-magnetic toner and magnetic carrier.

Further, according to embodiments of the present invention, there is provided a toner supply method of an image forming apparatus which has an image carrier on which plural latent images are formed repeatedly, plural first developing units containing specified color developers arranged in the rotating direction, color developing units provided to arrange the plural first developing units selectively to oppose to the image carrier and develop the latent images by specific color developers, and a second developing unit arranged at a position opposing to the image carrier at a position differing from the position the first developing units of the color developing device are opposed to the image carrier and supply a specific color developer to develop the latent images, the method comprising: detecting toner density of two-component developer contained in the first developing units arranged opposing to next to the applicable first developing unit when the color developing device is rotated and the first developing unit is opposed to the image carrier; storing the toner density detected value of the first developing units; and controlling the toner supply to the applicable first developing units based on the stored toner density detected value of the first developing unit when the color developing device is rotated and the next first developing unit is arranged to oppose to the image carrier.

### BRIEF DESCRIPTION OF THE DRAWINGS

FIG. 1 is a cross-sectional view schematically showing the internal structure of a color copier involved in the embodiment of the present invention;

FIG. 2 is a block diagram schematically showing the structure of the control system of the color copier shown in FIG. 1;

FIG. 3 is a flowchart for explaining the color image forming operation of the color copier shown in FIG. 1; and

FIG. 4 is a graph for explaining the infrared light reflection coefficient characteristic of each color toner.

### DETAILED DESCRIPTION OF THE INVENTION

The embodiment of the present invention will be explained below in detail referring to the attached drawings.

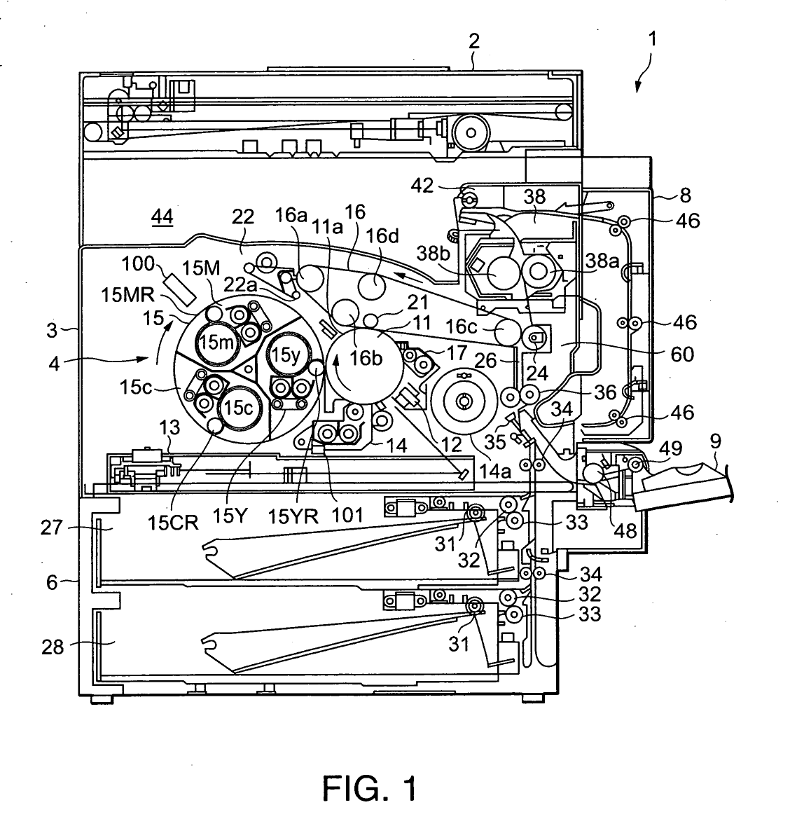

FIG. 1 schematically shows the inner internal structure of a color copier 1 as an image forming apparatus involved in the embodiment of the present invention.

The color copier 1 has a scanner unit 2, an image forming unit 4, and a paper supply unit 6. The scanner unit 2 illuminates an original set on a document table (not shown), leads the reflecting light from the original to a light receiving element through plural optical members, and outputs image data by the photoelectric transfer. The image forming unit 4 outputs an image based on image data region from the original by the scanner unit 2 or input from an external device (not shown) on a paper P (an image receiving medium). The paper supply unit 6 supplied a paper P to the image forming unit 4.

The color copier 1 has a housing 3 containing the above-mentioned units. On the right side surface of the housing 3, a paper reversing unit 8 and a manual paper supply unit 9 are installed detachably. The paper reversing unit 8 reverses a paper P with an image formed on which one side and supplies to the image forming unit 4 again. The manual paper supply unit 9 supplies a paper manually to the image forming unit 4.

The image forming unit 4 includes a photosensitive drum 11 (an image carrier) which has a rotary shaft extending in the front and rear direction (a paper direction) of the color copier 1. Around the photosensitive drum 11, a main charger 12, an exposure unit 13, a black developing device 14 (the second developing device), a revolver type color developing device 15 (a developing unit), an intermediate transfer belt 16 (an intermediate transfer means), and a drum cleaner 17 (a cleaning device) are provided along the rotating direction (the arrow direction in FIG. 1) of the photosensitive drum 11. The photosensitive drum 11 is needed in a diameter at least 50 mm so that the above-mentioned plural devices can be arranged around it.

The main charger 12 charges the outer surface 11a of the photosensitive drum 11 (hereinafter, referred to a drum surface 11a) to a specified potential. The exposure unit 13 is arranged near to the lower edge of the image forming unit 4 and forms an electrostatic latent image based on image data by exposing the drum surface 11a charged to a specified potential. When forming a color image, the exposure unit 13 forms electrostatic latent images in respective colors by exposing the drum surface 11a based on color separated image data.

The black developing device 14 is arranged between the photosensitive drum 11 and the exposure unit 13 to oppose to the photosensitive drum 11 from almost in the gravity direction. The black developing device 14 supplies a black developer to an electrostatic latent image formed on the drum surface 11a by the exposure unit 13 to develop and form a black developer image on the drum surface 11a. The black developing device 14 has a mixer to stir and supply a developer and a developing roller arranged to oppose to the drum surface 11a through a specified developing gap. Further, the black developing device 14 is provided movably to detach the developing roller to the drum surface 11a. Further, the black developing device 14 is supplied with a developer from a toner cartridge 14a.

The black developing device 14 is provided with a magnetic sensor 101.

The developer type color developing device 15 is provided adjacent to the photosensitive drum 11 nearly at the left side in FIG. 1. The developer type color developing device 15 has a yellow developing device 15Y (a first developing device), a magenta developing device 15M (a first developing device), and a cyan developing device 15C (a first developing device) which are basically in the almost same structure as the black developing device 14. These developing devices (15Y, 15 and 15C) are housed in the revolver type color developing device 15 detachably side by side in its rotating direction. Each of the developing devices has a toner cartridge 15y, 15m and 15c containing developers in respective colors, and a developing roller 15YR, 15MR and 15CR, respectively.

Further, a toner density detector 100 to sense toner density in each developing device (15Y, 15M and 15C) is provided near the revolver type color developing device 15. The toner density detector 100 is provided at a position opposite to a developing roller (15YR, 15MR and 15CR) of applicable developing unit where a developing device (15Y, 15M and 15C to form a developer image in next color of the revolver type color developing device 15 is waiting. The toner density detector 100 is a sensor to sense toner density of 2-component developer comprising an infrared light emitting element and a light receiving element to receive the infrared light reflecting from a developer on a developing roller (15YR, 15MR and 15CR).

The developing units in respective colors 15Y, 15M and 15C regions arranged to opposite to the drum surface 11a selectively from almost the side of the photosensitive drum 11 by rotating the revolver type developing device clockwise.

The black developing device 14 is provided separately from the revolver type color developing device 15 because its using frequency is higher than other color developing devices. As a result, it becomes possible to make the black developing device and the volume of developer in a toner cartridge larger and the number of maintenance such as exchange of developer, toner supply, etc. can be reduced.

Further, the black developing device 14 and the revolver type color developing device 15 in this embodiment are provided at positions outside the upper region in the gravity direction from the photosensitive drum 11 and therefore, it is able to prevent the undesirable scattering of developers from the developing devices 14, 15Y, 15M and 15C on the photosensitive drum 11.

The intermediate transfer belt 16 is arranged at a position where it contacts the photosensitive drum 11 from almost above in the gravity direction. The intermediate transfer belt 16 is stretched around a driving roller 16a, a pre-transferring roller 16b, a transferring roller 16c, and a tension roller 16d each of which has a rotary shaft extending in the front/rear direction. The driving roller 16a is provided statically to the housing 3 above the revolver type color developing device. The pre-transferring roller 16b is provided statically to the housing 3 above the photosensitive drum 11. The transferring roller 16c is provided statically at a position to contact the vertical transfer path that will be described later. The tension roller 16d is energized to the outside from the inside of the intermediate transfer belt 16 to give a specified tensile force to the intermediate transfer belt 16.

In addition, a primary transferring roller 21 is provided in the inside of the intermediate transfer belt 16 to bring the intermediate transfer belt 16 to contact the drum surface 11a and transfer a developer image formed on the drum surface 11a to the intermediate transfer belt 16. The primary transfer roller 21 is energized in the direction of the photosensitive drum 11 so as to press the intermediate transfer belt 16 to the drum surface 11a at a specified pressure.

Further, the intermediate transfer belt 16 is set in a length nearly integral multiple of the outer circumferential length of the photosensitive drum 11. In other words, the intermediate transfer belt 16 is set in a length so that the same portion of the drum surface 11a always contacts the same position. The intermediate transfer belt 16 is needed at least in a length more than the length of the longest paper P (431.8 mm) and the photosensitive drum 11 is also needed in a diameter more than at least 50 mm. Therefore, in this embodiment, the intermediate transfer belt 16 is set in the minimum required length at 3 times of the outer circumferential length of the photosensitive drum 11.

Around the intermediate transfer belt 16, a belt cleaner 22 (a cleaning device) and a secondary transfer roller 24 (a transfer device) are provided in the state able to contact/separate to/from the belt surface. The belt cleaner 22 is provided on the outer surface of the driving roller 16a through the intermediate transfer belt 16 above the revolver type color developing device 15. In other words, the belt cleaner 22 is provided at a position outside the above region in the gravity direction from the photosensitive drum 11. The second transfer roller 24 is provided at a position clamping the vertical conveying path 26 which is described later between the transfer roller 16c through the intermediate transfer belt 16.

The drum cleaner 17 is arranged in contact with the photosensitive drum 11 from the right side in FIG. 1. In other words, the drum cleaner 17 is provided at a position outside the region above the photosensitive drum 11.

That is, in this embodiment, the black developing device 14, the revolver type color developing device 15, the drum cleaner 17, and the belt cleaner 22 are provided at positions outside the region above the photosensitive drum 11. Further, in this embodiment, the intermediate transfer belt 16 is arranged above the photosensitive drum 11. Therefore, according to this embodiment, developers undesirably scattered or leaked from the black developing device 14, the revolver type color developing device 15, the drum cleaner 17, and the belt cleaner 22 do not fall on the drum surface 11a and the intermediate transfer belt 16 and therefore, defective images resulting from adherence of developers can be prevented.

The paper supply unit 6 has two paper supply cassettes 27 and 28 in layers. At the right upper end of the paper supply cassettes 27 and 28 in FIG. 1, a pick-up roller 31 is provided to take out the top paper P housed in the cassettes, respectively. At the position adjacent to the downstream side in the paper take-out direction by the pick-up roller 31, a forwarding roller 32 and a separation roller 33 region kept in contact with each other.

Further, at the positions adjacent to the right side of the paper supply cassettes 27 and 28 in FIG. 1, a vertical direction conveying path 26 extending almost in the vertical upper direction passing through the secondary transfer region in contact with the above-mentioned intermediate transfer belt 16 and the second transfer roller 24 is provided. On the vertical conveying path 26, a conveying roller pair 34 which rotates by holding a paper P, an aligning sensor to sense the arrival of a paper P, and a aligning roller pair 36 to supply a paper P to the secondary transferring region at a specified paper supply timing region arranged toward the second transferring region from the lower part.

On the vertical conveying path 26 extending upward by passing the secondary transferring region, a fixing device 38 is provided to fix a developer image transferred on a paper P by heating and pressing. The fixing device 38 has a heat roller 38b having a built-in heater and a pressure roller 38a arranged to the heat roller 38b by pressing.

That is, in this embodiment, the vertical conveying path 26 is extended by passing the position separated from the revolver type color developing device 15, that is, to the right side of the photosensitive drum 11 in FIG. 1. In other words, the vertical conveying path 26 is extended by passing a position outside the lower region in the gravity direction from the black developing device 14, the revolver type color developing device 15, and the belt cleaner 22. Thus, the adhesion of developers undesirably scattering from the black developing device 14 and the developing devices 15Y, 15M and 15C of the revolver type color developing device 15 to paper P conveyed through the secondary transferring region can be prevented. Accordingly, it is also possible to prevent that developers leaked undesirably from the drum cleaner 17 and the belt cleaner 22 falls on paper P.

Further, as the above-mentioned vertical conveying path 26 was adopted, the entire structure of the color copier 1 could be downsized and it becomes easy to make the paper jam processing. That is, the size of the entire apparatus could be made small as the devices in the vertical direction were made small by arranging the relatively large revolver type color developing device 15 at the left side of the photosensitive drum 11 as shown in FIG. 1 and the paper P conveying path was made short by adopting the vertical conveying path 26. Further, the vertical conveying path 26 in the vicinity of the secondary transferring region could be exposed easily to the outside of the housing 3 by opening the paper reversing unit 8 and a secondary transferring unit 60. As a result, even when the paper jam is caused in the vicinity of the secondary transferring region, the jam processing can be made easily.

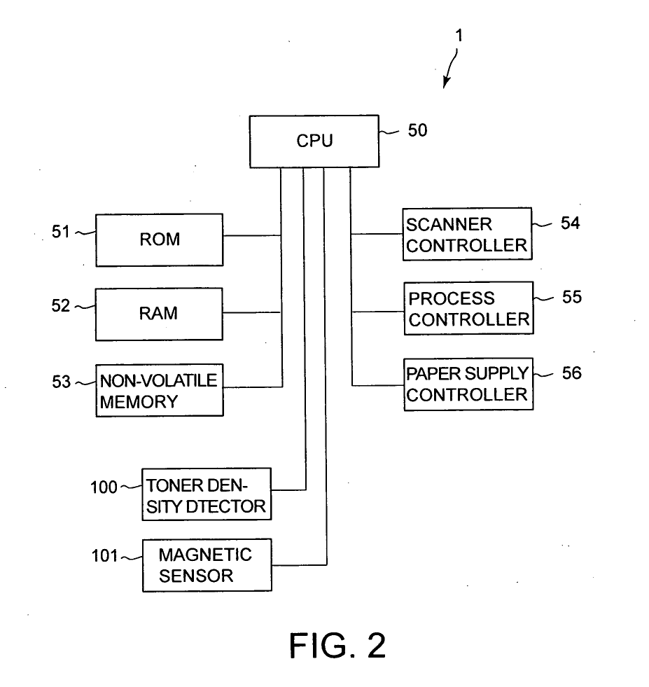

FIG. 2 shows a schematic structure of the control system of the color copier 1. That is, the color copier 1 is composed of: a CPU 50 to control the entire apparatus; a ROM 51 storing a control program and others; a RAM 52 for staring data; a non-volatile memory 53 to once store sensed values of toner density; which will be described later; a scanner controller 54 to control the scanner unit 2; a process controller 55 to control the image forming unit 4; and a paper supply controller 56 to control the paper supply unit 6.

Further, the CPU 50 is connected with a toner density detector 100 to detect toner density in the yellow developing device 15Y, the magenta developing device 15M and the cyan developing device 15C, and a magnetic sensor 101 provided in the black developing device 14.

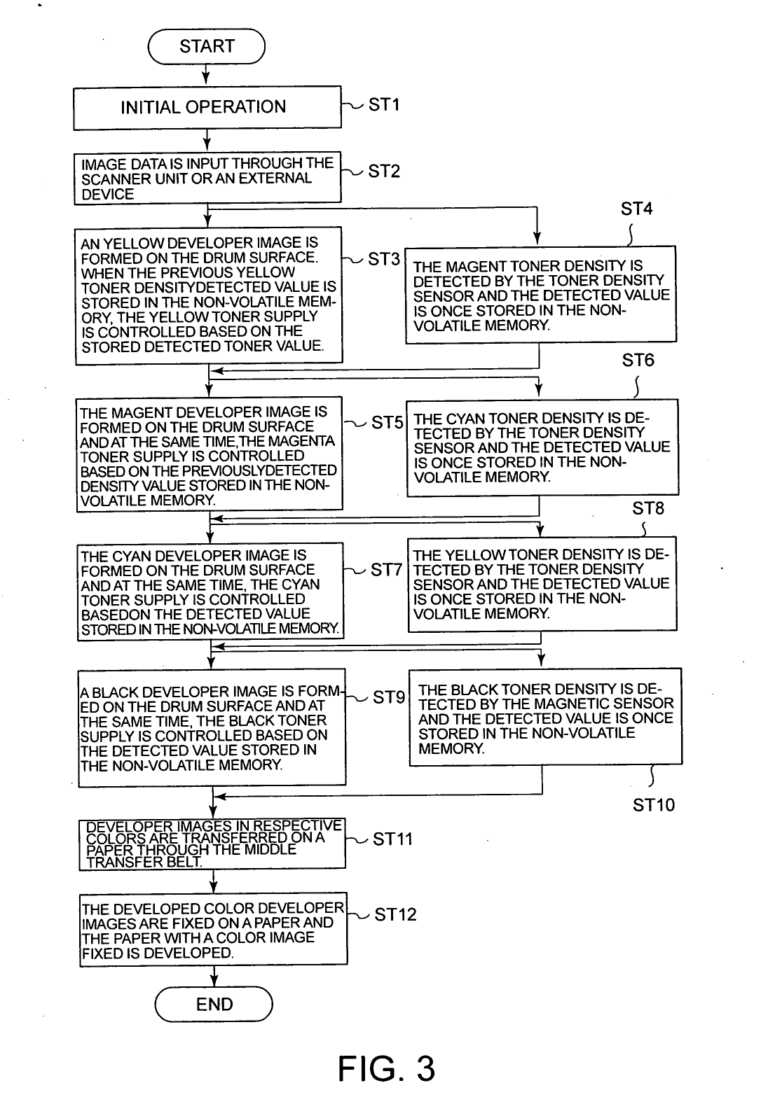

Next, the color image forming operation of the color copier 1 in this structure will be explained referring to the flowchart shown in FIG. 3. Further, the operations described below are controlled by the CPU 50.

As the initial operation, the black developing device 14 is moved downward and separated from the drum surface 11a and the revolver type color developing device 15 is rotated clockwise and the yellow developing device 15Y is opposed to the drum surface 11a. Further, the belt cleaner 22 is rotated counterclockwise centering around the shaft 22a and separated from the intermediate transfer belt 16. The secondary transfer roller 24 is moved in the direction to separate from the vertical conveying path 26 (the right direction in FIG. 1) and separated from the intermediate transfer belt 16 (ST 1).

Then, image data are read from a document (not shown) through the scanner 2 or image data are input from an external device (not shown) (ST2). Further, the photosensitive drum 11 is rotated clockwise and the drum surface 11a is uniformly charged to a specified potential by the main charger 12. At this time, the intermediate transfer belt 16 is also rotated counterclockwise.

Further, the exposure unit 13 is operated based on color separated yellow image data and a yellow electrostatic latent image is formed on the drum surface 11a. The exposure timing at this time is acquired by sensing a sensing mark (not shown) pasted on the inside of the intermediate transfer belt 16 by a sensor (not shown).

In succession, the yellow developer is supplied to an electrostatic latent image formed on the drum surface 11a through the yellow developing device 15Y, the yellow electrostatic latent image is developed and formed on the drum surface 11a (ST3). Further, when a yellow toner density value sensed previously was stored in the non-volatile memory 53, the toner supply to the yellow developing device 15Y from the toner cartridge 15y is controlled based on the sensed value.

The yellow developer image thus formed on the drum surface 11a is moved by the rotation of the photosensitive drum 11 and passes through the primary transfer region adjacent to the intermediate transfer belt 16.

At this time, bias of reverse polarity to the potential of the yellow developer image is given to the yellow developer image formed on the drum surface 11a by the primary transfer roller 21 and the yellow developer image is transferred on the intermediate transfer belt 16. As the intermediate transfer belt 16 is set in the length integral multiple of that of the outer circumference of the photosensitive drum 11, the developer image is transferred to the same position on the intermediate transfer belt 16 from the drum surface 11a.

After the yellow developer image was transferred on the intermediate transfer belt 16, the residual yellow developer left on the drum surface 11a without transferred is removed by the drum cleaner 17. At this time, the residual charge on the drum surface 11a is also eliminated. While the yellow developing device 15Y is opposed to the drum surface 11a and forming the yellow developer image thereon, the developer toner density of the magenta developing device 15M is detected. The detected value of this magenta toner density is once stored in the non-volatile memory 53 (ST4).

Then, as the preparation to form a next magenta electrostatic latent image on the drum surface 11a, the drum surface 11a is uniformly charged by the main charger 12. Then, the revolver type color developing device 15 is rotated and the magenta developing device 15 is opposed to the drum surface 11a and a magenta developer image is formed on the drum surface 11a. At the same time, based on a magenta toner density sensed value stored in the non-volatile memory 53, the toner supply into the magenta developing device 15M from the toner cartridge 14m is controlled (ST5).

Further, at the same time, the toner density of the developer of the cyan developing device 15C to form a next color developer image is detected. This detected value of the cyan toner density is once stored in the non-volatile memory 53 (ST6).

In succession, the revolver type color developing device 15 is rotated and the cyan developing device is opposed to the drum surface 11a and a cyan developer image is formed on the drum surface 11a. At the same time, based on a magenta toner density sensed value stored in the non-volatile memory 53, the toner supply into the magenta developing device 15M from the toner cartridge 15m is controlled (ST5).

Further, at the same time, the toner density of the developer of the cyan developing device 15C to form a next color developer image is detected by the toner density detector 100. This cyan toner density sensed value is once stored in the non-volatile memory 53 (ST6).

In succession, the revolver type color developing device 15 is rotated to oppose the cyan developing device 15C to the drum surface 11a, and a cyan developer image is formed on the drum surface 11a. At the same time, based on a magenta toner density sensed value stored in the non-volatile memory 53, the toner supply into the cyan developing device 15C from the toner cartridge 15c is controlled (ST7).

A series of operations described above; that is, the exposures→development→transfer to the intermediate transfer belt 16 are executed and a magenta developer image is transferred over a yellow developer image on the intermediate transfer belt 16. Thus, after the magenta developer image was transferred, the cyan developer image is transferred over the magenta developer image on the intermediate transfer belt 16.

In succession, the revolver type color developing device 15 is rotated and the cyan developing device 15C is opposed to the drum surface, and while a cyan developer image is being formed, the developer toner density of the yellow developing device 15Y is sensed. This sensed yellow toner density value is once stored in the non-volatile memory 53 (ST8).

At the next time, when the yellow developing device 15Y is rotated and moved to the position opposite to the drum surface 11a in the print operation, the supply of a toner into the yellow developing device 15Y from the toner cartridge 15y is prepared based on the yellow toner density sensed value stored in the non-volatile memory 53.

Then, the revolver type color developing device 15 is rotated to a home position of each developing device 15Y, 15M and 15C not opposite to the drum surface 11a and the black developing device 14 is raised to oppose to the drum surface 11a and a black developer image is formed. At the same time, the toner supply into the black developing device 14 from the toner cartridge 14a is controlled based on the black toner sensed value stored in the non-volatile memory 53 (ST9). Under this state, the same process as that described above is executed and a black developer image is transferred to the intermediate transfer belt 16 over the yellow, magenta and cyan developer images.

Further, a 2-component black developer is contained in the black developing device 14 and the toner density is sensed. This sensed value of the black toner density is also once stored in the non-volatile memory 53 (ST10).

The toner supply into the black developing device 14 from the toner cartridge 14a is controlled based on this stored density value. Further, the black developing device 14 is composed separately from the rotating revolver type color developing device 15 and is so arranged as to move to a position separate from a position opposite to the drum surface by a cam (not shown).

Thus, when all color developer images are superposed each other on the intermediate transfer belt 16, the secondary transfer roller 24 is moved leftward in FIG. 1 and comes in contacted with the intermediate transfer belt 16. Under this state, all color developer images superposed on the intermediate transfer belt 16 are moved with the rotation of the intermediate transfer belt 16 and passes the secondary transfer region between the belt 16 and the secondary transfer roller 24. Thereafter, when the top portion of the secondary transfer completed region comes to the belt cleaner position, the belt cleaner 22 also comes in contact with the intermediate transfer belt 16.

At this time, papers P taken out from the cassettes 27 and 28 are conveyed upward on the vertical conveying path 26 by the conveying roller pair 34 and after aligned once by the aligning roller pair 36, conveyed into the secondary transfer region at a specified timing.

Then, a bias in reverse polar to the potential of the color developer images is applied by the secondary transfer roller 24 and the color developer images on the intermediate transfer belt 16 are transferred on papers P (ST11). After the developer images are transferred on a paper P, developers remained on the intermediate transfer belt 16 are removed by the belt cleaner 22.

Thereafter, the paper P with the color developer images transferred in a lump passes through a fixing device 38 wherein it is heated and pressurized and the color developer images are fixed on the paper P and a color image is formed. The paper P with a color image thus formed is discharged on a discharged document receiving tray 44 by the discharging roller 42 provided at the downstream side of the fixing device 38 (ST12). In this embodiment, the discharge tray 44 is provided inside of the housing 3.

Next, the 2-component developer toner density detector 100 comprising an infrared light emission element and a light receiving element to receive the infrared light reflecting from developers on the developing rollers will be explained.

In this embodiment, a light emitting diode (LED) of waveform 880 nm is used as an infrared light emitting element. Regarding emission wavelength, any wavelength above 780 nm is usable. It depends upon spectral reflection coefficient of toner.

In general, non-magnetic toner for 2-component developer is composed of resin, wax, charge control agent, pigment, additive, etc. and yellow, magenta and cyan toners have a characteristic to reflect the light in the infrared region. The magnetic carrier used in this embodiment is a general carrier used in a color copier available in the market at present and is ferrite carrier thinly coated with resin. This carrier has a feature to absorb infrared light and when toner density becomes thick, a toner amount covering the carrier surface increase and therefore, the reflecting light from toner increases, accordingly.

The black toner has a feature to absorb the light ranging from the visible light to the infrared light region and therefore, the toner density detector 100 is not able to sense its toner density. That is, the carrier surface and the toner infrared light reflection feature are almost same and it is difficult to sense toner density.

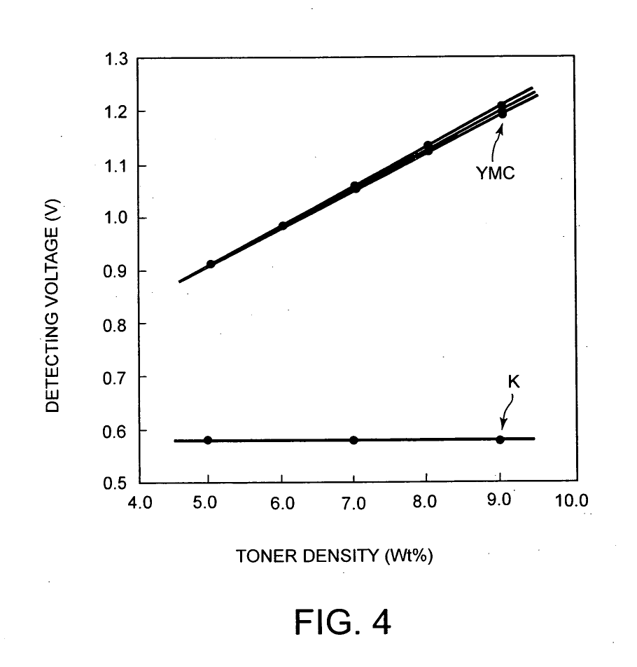

FIG. 4 is a graph showing these results. Regarding the yellow (Y), magenta (M) and cyan (C) toners, largely inclined linear outputs are obtained for toner density. However, as to the black toner, the output is flat and not usable for the sensing of toner density (the sensing was not attained by the present technology but there is the possibility for developing a sensor and/or carrier capable of sensing black toner density in the future).

It is described above that the toner density detector 100 is installed at a position opposite to the developing roller. When explaining more in detail, if the toner density sensor was opposed to the developing roller at the position of the main pole (a magnet pole to form a developer image at a position opposite to the photosensitive drum 11), a developer is in the erected state and the toner density detector 100 is largely affected by the reflecting light from the developer roller itself and cannot be used.

So, in this embodiment, the toner density detector 100 is arranged between the developing rollers so as to oppose to the portion where the developer on the developer roller is not in the erected state.

The place to install the toner density detector 100 is desired to be such a place where another developing device is waiting when a certain color developing device is at the position in opposite to the photosensitive drum. In this embodiment, the toner density sensor is installed at a position turned by 120 degree counterclockwise from a developing device opposing to the photosensitive drum 11 almost above the developing devices and therefore, is hardly affected by toners scattering from the developing devices. It is not impossible to look a developer on a developing roller of a developing device at the position opposite to the photosensitive drum 11 but the apparatus becomes a large size and may have a large defect as a product.

Accordingly, when the revolver type color developing device 15 is rotated by at least one turn, it becomes possible to sense all developer toner density in the revolver type color developing device 15. In the color image forming, the toner density can be sensed in the single sheet printing or the continuous printing without interrupting the print job and undesirably wasting toners by forming a toner density sensing patch between sheets of paper.

Further, when the black developing device containing black developer is housed in the revolving type color developing device, the toner density detector 100 is installed at a place where another developing device is waiting when a certain color developing device is at a position opposite to the photosensitive drum 11 even if a sensor or a carrier capable of sensing a black toner density was developed by a technology in the future. Therefore, in the continuous black printing job, the toner density of black developer cannot be sensed by the toner density detector 100. So, in order to sense the toner density, the continuous printing job must be interrupted and the density of black developer toner must be sensed by rotating the revolver type color developing device 15 with the toner density detector 100 or the black toner density must be sensed according to adhered toner amount using another density sensor by forming a black developer image patch.

In any case, the printing speed performance drop, undesirable toner waste and a large defect will result. However, it is possible to incorporate a black developing device that is used exclusively in the color image forming into the revolver type color developing device 15. In this case, the single black color printing developing device must be absolutely a secondary developing device. This is for sensing toner density without problems in single sheet printing as well as continuous printing of colors and black images. The incorporation of a 4 color first developing devices of yellow, magenta, cyan and black into the revolver type color developing devices and arrangement of a second developing device for exclusive use for black printing are also included in the present invention.

The rotating operation of the revolver type color developing device is associated in the color image forming and therefore, toner density of developers of all developing devices can be sensed and regardless of the continuous print or a single sheet printing, toner density of developers can be sensed without forming a patch for toner density sensing on the developing rollers. Accordingly, it is possible to form images without lowering the continuous print speed performance and undesirably wasting toners by forming patches.

Next, the black image forming operation by the color copier 1 will be explained.

As the initial state, the black developing device 14 is moved downward and separated from the drum surface 11a and the developing devices (15Y, 15M and 15C) of the revolver type color developing device are at the positions not opposing to the drum surface 11a. Further, the belt cleaner 22 is energized in the direction to rotate the shaft 22a clockwise and is in contact with the intermediate transfer belt 16, and the secondary transferring roller 24 is moved in the direction (the rightward in FIG. 1) to get away from the vertical direction conveying path 26 and is at the position away from the intermediate transfer belt 16.

Then, image data are read from a document (not shown) by the scanner unit 2 or image data are input from an external device (not shown). Further, the photosensitive drum 11 is rotated clockwise and the drum surface 11a is uniformly charged to a specified potential by the main charger 12. At this time, the intermediate transfer belt 16 is also rotated counterclockwise.

Further, the exposure unit 13 is operated based on the black image data and a black electrostatic latent image is formed on the drum surface 11a. The exposing timing at this time is not required to comply with a sensing mark (not shown) pasted inside the intermediate transfer belt 16 but the exposure is started by another signal.

This is because it is not necessary to superpose colors on the intermediate transfer belt 16 and also, a first print time can be made short.

In succession, the black developing device 14 is opposed to the drum surface 11a, a black developer is supplied to an electrostatic latent image, the black electrostatic latent image is developed and the black developer image is formed on the drum surface 11a. The black developer image thus formed on the drum surface 11a is moved with the rotation of the photosensitive drum 11 and passes through the primary transfer region contacting the intermediate transfer belt 16.

At this time, bias of polarity reverse to the potential of the black developer image is given through the primary transferring roller and the black developer image on the drum surface 11a is transferred on the intermediate transfer belt 16.

Thereafter, the black developer image is conveyed to the secondary transfer region and contacted to the intermediate transfer belt 16. Then, the black developer image is transferred on a paper P likewise the color image forming, fixed in the fixing device 38 and discharged on the discharged document receiving tray 44.

In case of the black printing, the revolver type color developing device 15 is not rotated and therefore, in both the single sheet and continuous sheet printing, the black image printing can be made in the same manner as described above likewise an ordinary exclusive black image forming apparatus.

As to the toner density control, 2-component developer for black printing is contained in the black developing device 14 as explained in the color image forming and toner density is sensed by the magnetic sensor 101 in order to sense this toner density. The sensed toner density is once stored in the non-volatile memory 53 and based on this sensed toner density value, toner supply to the black developing device 14 from the toner cartridge 14a is controlled.

The toner supply can be made during the same single printing job or based on the sensed value stored in the previous printing job.

This toner density sensing and toner supply operation can be made in the single sheet printing and the continuous printing without problems and the stable toner density can be controlled. Further, it is not required to make the undesirable patch printing for the toner density sensing and the continuous printing speed performance is not lowered and toner is not wasted undesirably.

As described above, the black developing device 14 is provided separately from the revolver type color developing device 15 containing other color developing devices. Thus, the amount of black developer contained in the black developing device and the toner cartridge can be made large differing from other color developing units and as a result, the number of maintenance such as Exchange of developers, toner supply, etc. can be reduced largely.

The image forming apparatus of the present invention uses 2-component developer and is capable of preventing defective images resulting from adherence of developer, and reducing the number of maintenance without lowering continuous printing speed performance and undesirable wasting of toner by patch forming.

Further, the present invention is not limited to the embodiment described above but modified variously within the scope thereof.

For example, the toner density detector 100 is composed of an infrared light emitting element and a receiving element to receive infrared light reflecting from developers and the sensing position can be any position not opposing to the developing roller. A transparent window may be provided at a part of a developing unit to sense toner density of developer inside the unit through the window.

Further, needless to say, various publicly known 2-component color developer toner density sensor are usable.

In addition, for the toner density detecting method of the black developing device, publicly known toner density sensors other than magnetic sensors are usable according to the black developing device described above.

1. An image forming apparatus comprising:
an image carrier on which plural latent images are formed repeatedly;
a color developing device which has plural first developing units containing specified color developers arranged side by side in a rotating direction and are able to rotate the plural first developing units to oppose to the image carrier selectively and develop the latent images by supplying specified color developers;
a second developing device arranged along the outer surface of the image carrier at a position differing from the position where the first developing units of the color developing device is opposed to the image carrier, and opposes to the image carrier and develops the latent image by supplying a specified color developer;
a first toner density detecting measns for detecting a toner density of the developers contained in the first developing units, wherein the developers are two-compoent developer comprising at least non-magnetic toner and magnetic carrier; and
a second toner density detecting means for detecting the toner densitiy of the developers contained in the second developing device of which detecting method differs from the first toner density detecting means, wherein the developer is a two-component developer comprising at least non-magnetic toner and magnetic carrier.

2. The image forming apparatus as claimed in claim 1 further comprising:
memory means for storing toner density values detected by the first and the second toner density detecting means.

3. The image forming apparatus as claimed in claim 2 further comprising:
control means for controlling the toner supply to the applicable first developing unit based on the toner density detected value stored in the memory means when the color developing device is rotated and a next first developing unit is arranged to oppose to the image carrier.

4. The image forming apparatus as claimed in claim 2 further comprising:
control means for controlling the toner supply to the second developing unit based on the toner density detected value stored in the memory means.

5. The image forming apparatus as claimed in claim 1, wherein the color developing device is opposed to the image carrier from about the side and the second developing unit is opposed to the image carrier from about the lower side.

6. The image forming apparatus as claimed in claim 1, wherein the first toner density detecting means includes a sensor to detect amount of reflecting light of infrared light irradiated to the developer.

7. The image forming apparatus as claimed in claim 1, wherein the first toner density detecting means detects the developer toner density in the first developing unit at the waiting position when the plural first developing units are selectively arranged to oppose to the image carrier.

8. The image forming apparatus as claimed in claim 1, wherein the second toner density detecting means includes a magnetic sensor.

9. The image forming apparatus as claimed in claim 1, wherein the color of developers contained in the plural first developing units are at least yellow, magenta and cyan.

10. The image forming apparatus as claimed in claim 1, wherein the developer color contained in the second developing unit is black.

11. The image forming apparatus as claimed in claim 1, wherein the amount of developer contained in the second developing unit is much more than the amount of developers contained in the first developing units in the color developing device.

12. An image forming apparatus comprising:
an image carrier on which plural latent images are formed repeatedly;
a color developing device which has plural first developing units containing specified color developers arranged side by side in a rotating direction and are able to rotate the plural first developing units to oppose to the image carrier selectively and develop the latent images by supplying specified color developers;
a second developing device arranged along the outer surface of the image carrier at a position differing from the position where the first developing units of the color developing device is opposed to the image carrier, and opposes to the image carrier and develops the latent image by supplying a specified color developer;
a first toner density detector to detect toner density of the developers contained in the first developing units, wherein the developers are two-compoent developer comprising at least non-magnetic toner and magnetic carrier; and
a second toner density detector to detect the toner densitiy of the developers contained in the second developing device of which detecting method differs from the first toner density detector, wherein the developer is a two-component developer comprising at least non-magnetic toner and magnetic carrier.

13. The image forming apparatus as claimed in claim 12 further comprising:
a memory to store toner density values detected by the first and the second toner density detectors.

14. The image forming apparatus as claimed in claim 13 further comprising:
a controller to control the toner supply to the applicable first developing unit based on the toner density detected value stored in the memory when the color developing device is rotated and a next first developing unit is arranged to oppose to the image carrier.

15. The image forming apparatus as claimed in claim 13 further comprising:
a controller to control the toner supply to the second developing unit based on the toner density detected value stored in the memory.

16. The image forming apparatus as claimed in claim 12, wherein the color developing device is opposed to the image carrier from abount the side and the second developing unit is opposed to the image carrier from the lower side.

17. The image forming apparatus as claimed in claim 12, wherein the first toner density detector includes a sensor to detect amount of reflecting light of infrared light irradiated to the developer.

18. The image forming apparatus as claimed in claim 12, wherein the first toner density detector detects the developer toner density in the first developing unit at the waiting position when the plural first developing units are selectively arranged to oppose to the image carrier.

19. The image forming apparatus as claimed in claim 12, wherein the second toner density detector includes a magnetic sensor.

20. The image forming apparatus as claimed in claim 12, wherein the color of developers contained in the plural first developing units are at least yellow, magenta and cyan.

21. The image forming apparatus as claimed in claim 12, wherein the developer color contained in the second developing unit is black.

22. The image forming apparatus as claimed in claim 12, wherein the amount of developer contained in the second developing unit is much more than the amount of developers contained in the first developing units in the color developing device.

23. An image forming apparatus comprising:
an image carrier on which plural latent images are formed repeatedly;
a color developing device which has plural first developing units containing specified color developers except black, respectively and arranged side by side in the rotating direction, and is able to rotate the plural first developing units to oppose to the image carrier selectively and develops the latent images by supplying specified color developers; and
a detector irradiates the infrared light to the developer in the developing unit which is at the waiting position when the plural developing units are selectively arranged to oppose to the image carrier and detects the amount of its reflecting light.

24. The image forming apparatus as claimed in claim 23 further comprising:
a black developing device arranged at a position along the image carrier opposing to it and at a position differing from the position where the developing units of the color developing device is opposing to the image carrier, supplies a black developer to the latent images and develops a black image, wherein the black developing unit is opposed to the image carrier from the lower side; and
a magnetic sensor to detect the density of the developer in the black developing device.

25. A toner supply method of an image forming apparatus which has an image carrier on which plural latent images are formed repeatedly, plural first developing units containing specified color developers arranged in the rotating direction, color developing units provided to arrange the plural first developing units selectively to oppose to the image carrier and develop the latent images by specific color developers, and a second developing unit arranged at a position opposing to the image carrier at a position differing from the position the first developing units of the color developing device are opposed to the image carrier and supply a specific color developer to develop the latent images, the method comprising:
detecting toner density of two-component developer contained in the first developing units arranged opposing to next to the applicable first developing unit when the color developing device is rotated and the first developing unit is opposed to the image carrier;
storing the toner density detected value of the first developing units; and
controlling the toner supply to the applicable first developing units based on the stored toner density detected value of the first developing unit when the color developing device is rotated and the next first developing unit is arranged to oppose to the image carrier.

26. The toner supply method as claimed in claim 25 further comprising:
detecting toner density of two-component developer contained in the second developing unit;
storing the detected toner density value of the second developing unit; and
controlling the toner supply to the second developing unit based on the stored detected toner density value of the second developing unit.
